(19) United States
(12) Patent Application Publication
(10) Pub. No.: US 2014/0049506 A1
(43) Pub. Date: Feb. 20, 2014

(54) TOUCH PANEL AND METHOD OF MANUFACTURING SAME

(71) Applicant: Chih-Chung Lin, Taipei City (TW)

(72) Inventor: Chih-Chung Lin, Taipei City (TW)

(21) Appl. No.: 13/606,220

(22) Filed: Sep. 7, 2012

(30) Foreign Application Priority Data
Aug. 20, 2012 (TW) 101130070

(51) Int. Cl. G06F 3/044; B32B 37/12

(52) U.S. Cl. 345/174; 156/60

(57) ABSTRACT

A touch panel and a method of manufacturing same are disclosed. The touch panel includes a backlight module, an LCD display unit disposed in a receiving space enclosed in a raised wall portion of the backlight module, a capacitive sensing layer arranged on one side of a first glass substrate of the LCD display unit, and a transparent substrate bonded by an adhesive layer to one side of the LCD display unit opposite to the backlight module. Any extra amount of the adhesive layer flowing out from between the LCD display unit and the transparent substrate forms an overflowed adhesive portion, which is also located in the receiving space and shielded by the raised wall portion of the backlight module. Therefore, the step of removing the overflowed adhesive portion can be saved to reduce the labor and time cost for assembling the touch panel.

This application claims the priority benefit of Taiwan patent application number 101130070 filed on Aug. 20, 2012.

### FIELD OF THE INVENTION

The present invention relates to a touch panel and a method of manufacturing same; and more particularly to a touch panel and a method of manufacturing same that can reduce the labor and time cost for assembling the touch panel.

### BACKGROUND OF THE INVENTION

Due to the quick development in the information technological and communication network fields, various kinds of electronic information products have become highly popular among consumers. Meanwhile, touch panels for electronic information products are also quickly developed. According to the sensing principles thereof, the currently available touch panels can be classified into four major types, namely, resistive, capacitive, electromagnetic, and optical touch panels. Among other, the capacitive touch panel is characterized by its good dust resistance, fire resistance and high definition, and is therefore widely welcomed among users. With the capacitive touch panel, the location of a touched point is determined from change in the capacitance of the touch panel. That is, the coordinates of the touched point on the touch panel is determined from the capacitance change between electrodes resulted from the approach of a conductive object, such as a finger, to the touch panel.

The capacitive touch panel has gradually become the mainstream in the touch technology and is applied to various electronic information products, such as cell phones, tablet computers, walkmans, hand-held electronic devices (apparatus), various displays, monitors, etc. According to the technological principle of these electronic information products, the capacitance change of the touch panel resulted from touch of the panel by a finger is used to detect the change of position of the finger on the touch panel and the function selected through touch, so as to achieve the purpose of controlling the display.

In assembling the capacitive touch panel, a display layer and a capacitive sensing layer thereof are usually bonded together using an optical clear resin (OCR) or an optical clear adhesive (OCA). After the display layer and the capacitive sensing layer are bonded together, an additional procedure is required to remove extra resin or adhesive that flows out from between the bonded display layer and capacitive sensing layer. This additional procedure inevitably increases the assembling time and labor costs.

In brief, the conventional method of manufacturing the capacitive touch panel has the following disadvantages: (1) high assembling labor cost; (2) long assembling time; and (3) high bad yield.

It is therefore tried by the inventor to develop an improved method of manufacturing touch panel to overcome the problems in the conventional touch panel manufacturing method.

### SUMMARY OF THE INVENTION

A primary object of the present invention is to provide a touch panel and a method of manufacturing same, so that time and labor cost for assembling the touch panel can be reduced.

To achieve the above and other objects, the touch panel according to a preferred embodiment of the present invention includes a backlight module, a liquid crystal display unit (LCD display unit), a capacitive sensing layer, and a transparent substrate. The backlight module has at least one raised wall portion formed along an outer periphery thereof to enclose a receiving space therein. The LCD display unit is disposed in the receiving space of the backlight module, and includes a first glass substrate, a liquid crystal layer and a second glass substrate sequentially stacked from top to bottom. The first glass substrate has a first side and an opposite second side, and the first side has an adhesive layer provided thereon. The capacitive sensing layer is selectively arranged on one of the first and the second side of the first glass substrate. The transparent substrate is arranged on one side of the LCD display unit opposite to the backlight module. When the transparent substrate is bonded to the LCD display unit via the adhesive layer, any extra amount of the adhesive layer flowing out from between the transparent substrate and the LCD display unit forms an overflowed adhesive portion, which is located in the receiving space and shielded by the raised wall portion of the backlight module.

To achieve the above and other objects, the method of manufacturing touch panel according to a preferred embodiment of the present invention includes the following steps: providing an LCD display unit, which includes a first glass substrate, a liquid crystal layer and a second glass substrate sequentially stacked from top to bottom, the first glass substrate having a first side and an opposite second side, and the first side having an adhesive layer provided thereon; providing a capacitive sensing layer and attaching it to one of the first and the second side of the first glass substrate of the LCD display unit; providing a transparent substrate and bonding it to the LCD display unit via the adhesive layer; and placing the LCD display unit in a receiving space defined on a backlight module, so that the transparent substrate is located opposite to the backlight module and an outer periphery of the LCD display unit is shielded by a raised wall portion of the backlight module.

When the transparent substrate is bonded to the LCD display unit via the adhesive layer, any extra amount of the adhesive layer will flow out from between the LCD display unit and the transparent substrate to form an overflowed adhesive portion, and the overflowed adhesive portion is located in the receiving space and shielded by the raised wall portion of the backlight module. Therefore, the step of removing the overflowed adhesive portion can be saved to reduce the labor and time cost for assembling the touch panel.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a sectional view of a touch panel according to a first preferred embodiment of the present invention;

FIG. 2 is a flowchart showing the steps included in a method of manufacturing touch panel according to the present invention;

FIG. 3 illustrates the forming of the touch panel according to the first preferred embodiment of the present invention;

FIG. 4A is a sectional view of a touch panel according to a second preferred embodiment of the present invention;

FIG. 4B illustrates the forming of the touch panel according to the second preferred embodiment of the present invention;

FIG. 5 is a sectional view of a touch panel according to a third preferred embodiment of the present invention; and

FIG. 6 is a sectional view of a touch panel according to a fourth preferred embodiment of the present invention.

### DETAILED DESCRIPTION OF THE PREFERRED EMBODIMENTS

The present invention will now be described with some preferred embodiments thereof and with reference to the accompanying drawings. For the purpose of easy to understand, elements that are the same in the preferred embodiments are denoted by the same reference numerals.

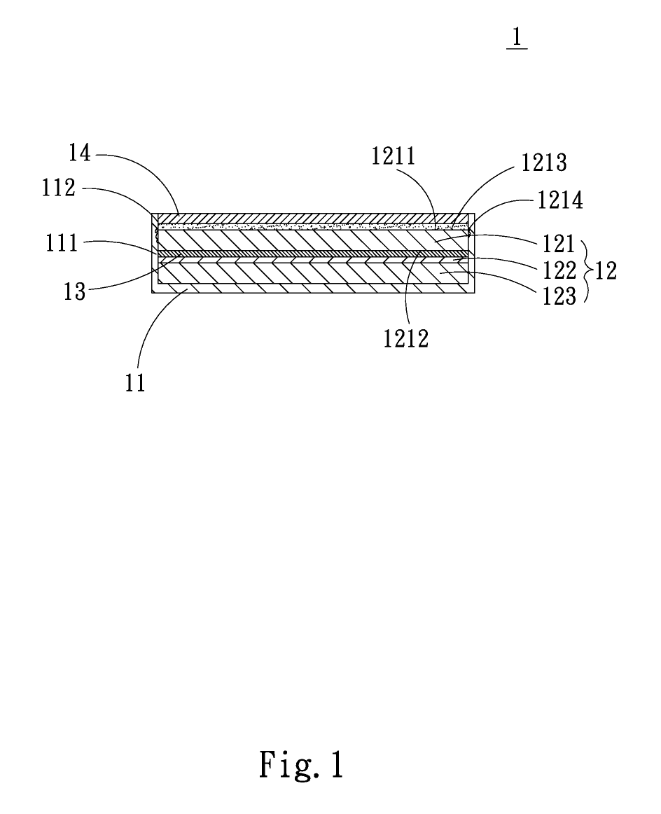

Please refer to FIG. 1 that is a sectional view of a touch panel 1 according to a first preferred embodiment of the present invention. As shown, the touch panel 1 in the first preferred embodiment includes a backlight module 11, a liquid crystal display unit (LCD display unit) 12, a capacitive sensing layer 13, and a transparent substrate 14.

The backlight module 11 has at least one raised wall portion 111 formed along an outer periphery thereof to enclose a receiving space 112.

The LCD display unit 12 is arranged in the receiving space 112. The LCD display unit 12 includes a first glass substrate 121, a liquid crystal layer 122 and a second glass substrate 123 sequentially stacked from top to bottom. That is, the liquid crystal layer 122 is located on a top of the second glass substrate 123, and the first glass substrate 121 is located on a top of the liquid crystal layer 122. The first glass substrate 121 has a first side 1211 and an opposite second side 1212, and the first side 1211 of the first glass substrate 121 has an adhesive layer 1213 provided thereon.

While the first preferred embodiment of the present invention is illustrated as including an LCD display unit 12 with a first glass substrate 121 and a second glass substrate 123, it is understood the first and second substrates are not necessarily limited to glass substrates but may also be made of polyethylene terephthalate (PET), polycarbonate (PC), polyethylene (PE), polyvinylchloride (PVC), polypropylene (PP), polystyrene (PS), polymethylmethacrylate (PMMA), or cyclo olefin copolymer (COC). Further, the adhesive layer 1213 may be a layer of optical clear resin (OCR) or a layer of optical clear adhesive (OCA).

The capacitive sensing layer 13 can be selectively arranged on one side of the first glass substrate 121. In the illustrated first preferred embodiment, the capacitive sensing layer 13 is arranged on the second side 1212 of the first glass substrate 121. That is, in the first preferred embodiment, the capacitive sensing layer 13 is located between the liquid crystal layer 122 and the first glass substrate 121. Moreover, the capacitive sensing layer 13 may be an indium tin oxide (ITO), an antimony tin oxide (ATO), or an indium zinc oxide (IZO). In practical implementation of the touch panel according to the present invention, the capacitive sensing layer 13 can be formed on the second side 1212 of the first glass substrate 121 by applying a gel layer, electrical plating, vapor deposition or etching.

The transparent substrate 14 is arranged on one side of the LCD display unit 12 opposite to the backlight module 11. In the illustrated first preferred embodiment, the LCD display unit 12 and the transparent substrate 14 are bonded together via the adhesive layer 1213. Any extra amount of the adhesive layer 1213 flowing out from between the bonded LCD display unit 12 and transparent substrate 14 forms an overflowed adhesive portion 1214, which is located in the receiving space 112 and shielded by the raised wall portion 111 of the backlight module 11. Therefore, the step of removing the overflowed adhesive portion 1214 can be saved to reduce labor and time cost for assembling the touch panel 1.

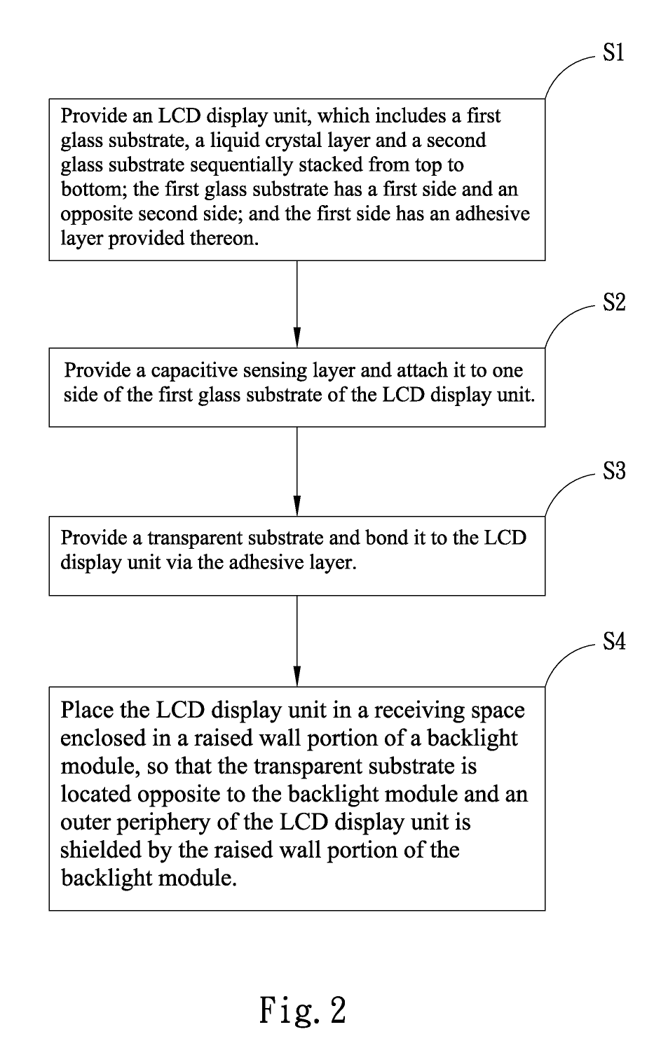

FIG. 2 is a flowchart showing steps S1 to S4 included in a preferred embodiment of a method of manufacturing touch panel according to the present invention. Please refer to FIGS. 1 and 2 at the same time.

In step S1, an LCD display unit 12 is provided. The LCD display unit 12 includes a first glass substrate 121, a liquid crystal layer 122 and a second glass substrate 123 sequentially stacked from top to bottom. The first glass substrate 121 has a first side 1211 and an opposite second side 1212, and the first side 1211 of the first glass substrate 121 has an adhesive layer 1213 provided thereon.

In step S2, a capacitive sensing layer 13 is provided and attached to one side of the first glass substrate 121.

In step S3, a transparent substrate 14 is provided and bonded to the LCD display unit 12 via the adhesive layer 1213.

In step S4, the LCD display unit 12 is positioned in a receiving space 112 enclosed in a raised wall portion 111 of a backlight module 11, so that the transparent substrate 14 is located opposite to the backlight module 11 and an outer periphery of the LCD display unit 12 is shielded by the raised wall portion 111 of the backlight module 11.

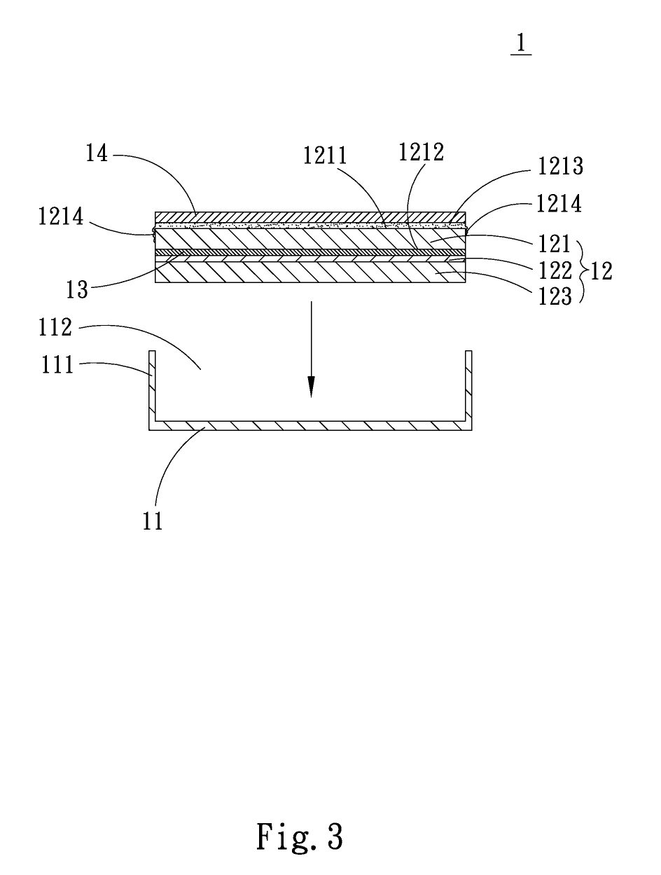

Please also refer to FIG. 3 that illustrates the forming of the touch panel 1 according to the first preferred embodiment of the present invention. As shown, to form the touch panel 1, an LCD display unit 12 is provided first. The LCD display unit 12 includes a first glass substrate 121, a liquid crystal layer 122 and a second glass substrate 123 sequentially stacked from top to bottom. The first glass substrate 121 has a first side 1211 and an opposite second side 1212, and the first side 1211 of the first glass substrate 121 has an adhesive layer 1213 provided thereon. Then, a capacitive sensing layer 13 is provided and attached to the first side 1211 or the second side 1212 of the first glass substrate 121. In implementing the first preferred embodiment, the capacitive sensing layer 13 is attached to the second side 1212 of the first glass substrate 121. Thereafter, a transparent substrate 14 is provided and bonded to one side of the LCD display unit 12 via the adhesive layer 1213, and any extra amount of the adhesive layer 1213 flowing out from between the LCD display unit 12 and the transparent substrate 14 forms an overflowed adhesive portion 1214. Finally, place the LCD display unit 12 in a receiving space 112 enclosed in a raised wall portion 111 of a backlight module 11, so that the transparent substrate 14 is located opposite to the backlight module 11, and an outer periphery of the LCD display unit 12 is shielded by the raised wall portion 111 of the backlight module 11. Accordingly, the overflowed adhesive portion 1214 is located in the receiving space 112 and shielded by the raised wall portion 111 of the backlight module 11. Then, a touch panel 1 as shown in FIG. 1 is completed.

By forming the touch panel 1 in the above-described manner, the overflowed adhesive portion 1214 formed during the bonding of the transparent substrate 14 to the LCD display unit 12 via the adhesive layer 1213 is shielded by the raised wall portion 111 of the backlight module 11. Therefore, the step of removing the overflowed adhesive portion can be saved to reduce the labor and time cost for assembling the touch panel.

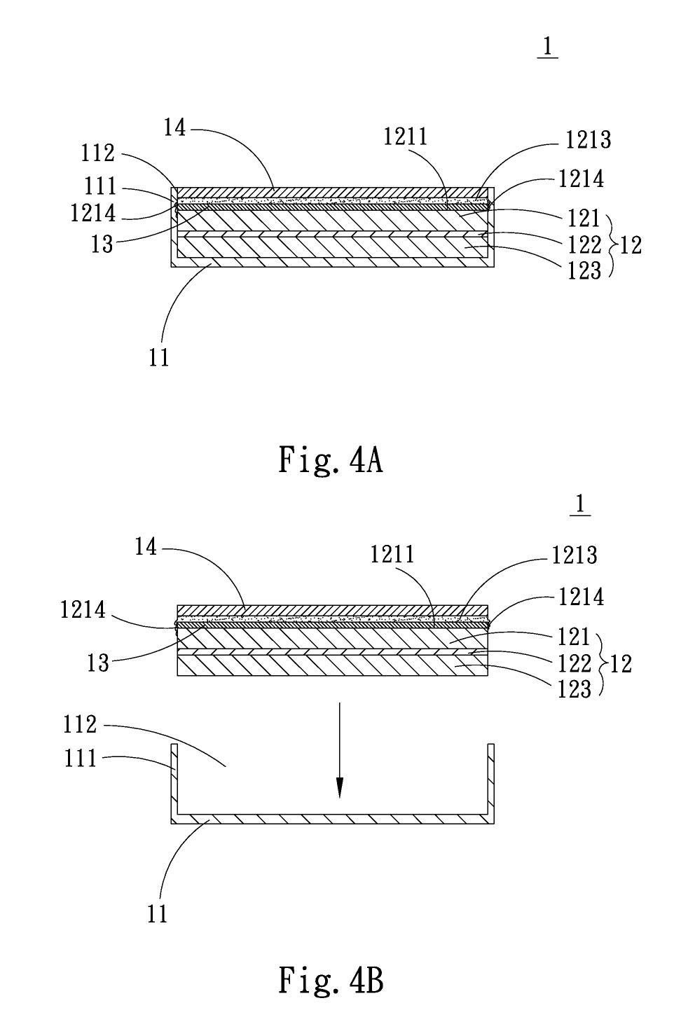

FIG. 4A is a sectional view of a touch panel 1 according to a second preferred embodiment of the present invention, and FIG. 4B illustrates the forming of the touch panel 1 according to the second preferred embodiment of the present invention. As shown, the touch panel 1 in the second preferred embodiment is generally structurally similar to the first preferred embodiment, except that, in the second preferred embodiment, the capacitive sensing layer 13 is located on the first side 1211 of the first glass substrate 121 of the LCD display unit 12 and the transparent substrate 14 is bonded to the capacitive sensing layer 13 via the adhesive layer 1213. In the second preferred embodiment, an overflowed adhesive portion 1214 of the adhesive layer 1213 is also formed during the bonding of the transparent substrate 14 to the capacitive sensing layer 13. When the LCD display unit 12 is placed in the receiving space 112 of the backlight module 11 and shielded by the raised wall portion 111 of the backlight module 11, the overflowed adhesive portion 1214 of the adhesive layer 1213 is also located in the receiving space 112 and shielded by the raised wall portion 111.

Therefore, with the touch panel 1 according to the second preferred embodiment of the present invention, the overflowed adhesive portion 1214 formed when the capacitive sensing layer 13 and the transparent substrate 14 are bonded together via the adhesive layer 1213 can be shielded by the raised wall portion 111 of the backlight module 11, and the step of removing the overflowed adhesive portion can be saved to reduce the labor and time cost for assembling the touch panel.

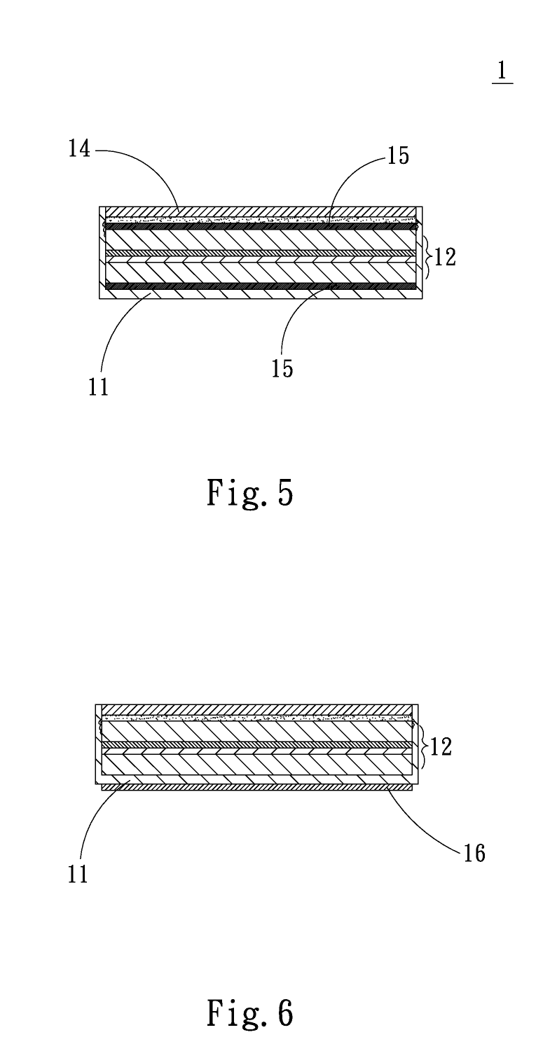

FIG. 5 is a sectional view of a touch panel 1 according to a third preferred embodiment of the present invention. As shown, the touch panel 1 in the third preferred embodiment is generally structurally similar to the first preferred embodiment, except that it further includes at least one polarization unit 15. The polarization unit 15 can be selectively provided at a position between the LCD display unit 12 and the backlight unit 11, or at a position between the LCD display unit 12 and the transparent substrate 14, or at both of the above two positions. In the illustrated third preferred embodiment, two polarization units 15 are separately provided at the position between the LCD display unit 12 and the backlight unit 11, and the position between the LCD display unit 12 and the transparent substrate 14.

FIG. 6 is a sectional view of a touch panel according to a fourth preferred embodiment of the present invention. As shown, the touch panel in the fourth preferred embodiment is generally structurally similar to the first preferred embodiment, except that it further includes an electromagnetic sensing layer 16 attached to one side of the backlight module 11 opposite to the LCD display unit 12.

Compared to the conventional touch panels, the touch panel manufactured according to the method of the present invention has the following advantages: (1) reduced assembling labor cost; (2) shortened assembling time; and (3) increased good yield.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A touch panel, comprising:
a backlight module having at least one raised wall portion formed along an outer periphery thereof to enclose a receiving space;
an LCD display unit being disposed in the receiving space of the backlight module, and including a first glass substrate, a liquid crystal layer and a second glass substrate sequentially stacked from top to bottom; the first glass substrate having a first side and an opposite second side; and the first side of the first glass substrate having an adhesive layer provided thereon;
a capacitive sensing layer being selectively arranged on one of the first and the second side of the first glass substrate; and
a transparent substrate being arranged on one side of the LCD display unit opposite to the backlight module.

2. The touch panel as claimed in claim 1, wherein the LCD display unit and the transparent substrate are bonded together via the adhesive layer, and any extra amount of the adhesive layer flowing out from between the LCD display unit and the transparent substrate forms an overflowed adhesive portion; and the overflowed adhesive portion being located in the receiving space and shielded by the raised wall portion of the backlight module.

3. The touch panel as claimed in claim 1, wherein the capacitive sensing layer and the transparent substrate are bonded together via the adhesive layer, and any extra amount of the adhesive layer flowing out from between the capacitive sensing layer and the transparent substrate forms an overflowed adhesive portion; and the overflowed adhesive portion being located in the receiving space and shielded by the raised wall portion of the backlight module.

4. The touch panel as claimed in claim 1, further comprising at least one polarization unit; and the polarization unit being selectively provided at a position between the LCD display unit and the backlight unit, or at a position between the LCD display unit and the transparent substrate, or at both of the above two positions.

5. The touch panel as claimed in claim 1, further comprising an electromagnetic sensing layer attached to one side of the backlight module opposite to the LCD display unit.

6. A method of manufacturing touch panel, comprising the following steps:
providing an LCD display unit, which includes a first glass substrate, a liquid crystal layer and a second glass substrate sequentially stacked from top to bottom; the first glass substrate having a first side and an opposite second side, and the first side of the first glass substrate having an adhesive layer provided thereon;
providing a capacitive sensing layer and attaching it to one of the first and the second side of the first glass substrate of the LCD display unit;
providing a transparent substrate and bonding it to the LCD display unit via the adhesive layer; and
placing the LCD display unit in a receiving space enclosed in a raised wall portion of a backlight module, so that the transparent substrate is located opposite to the backlight module and an outer periphery of the LCD display unit is shielded by the raised wall portion of the backlight module.

7. The touch panel manufacturing method as claimed in claim 6, wherein, in the step of placing the LCD display unit in the receiving space of the backlight module, the transparent substrate and the adhesive layer are also received in the receiving space.

8. The touch panel manufacturing method as claimed in claim 7, wherein, in the step of providing the transparent substrate and bonding it to the LCD display unit via the adhesive layer, any extra amount of the adhesive layer flowing out from between the LCD display unit and the transparent substrate forms an overflowed adhesive portion, and the overflowed adhesive portion being located in the receiving space and shielded by the raised wall portion of the backlight module.

9. The touch panel manufacturing method as claimed in claim 6, further comprising a step of providing at least one polarization unit and selectively arranging the polarization unit at a position between the LCD display unit and the backlight unit, or at a position between the LCD display unit and the transparent substrate, or at both of the above two positions.
